(19) United States
(12) Patent Application Publication
(10) Pub. No.: US 2007/0228259 A1
(43) Pub. Date: Oct. 4, 2007

(54) SYSTEM AND METHOD FOR FUSING AN IMAGE

(76) Inventor: Roger T. Hohenberger, Windham, NH (US)

Correspondence Address: INSIGHT TECHNOLOGY, INC.;ATTN: PETER W. MURPHY, NINE AKIRA WAY, LONDONDERRY, NH, 03053, US

(21) Appl. No.: 11/550,856

(22) Filed: Oct. 19, 2006

Related U.S. Application Data
(60) Provisional application No. 60/728,710, filed on Oct. 20, 2005.

(51) Int. Cl. H01J 43/00

(52) U.S. Cl. 250/214 LA

(57) ABSTRACT

A fusion vision system has a first sensor configured to detect scene information in a first range of wavelengths, a second sensor configured to detect scene information in a second range of wavelengths, and a processor configured to resize one of a first and a second image to improve viewability of the fused scene.

### CROSS REFERENCE TO RELATED APPLICATIONS

The present application claims the benefit of copending U.S. patent application Ser. No. 11/173,234, filed Jul. 1, 2005 and U.S. Provisional Patent Application Ser. No. 60/728,710, filed Oct. 20, 2005, the entire disclosures of which are incorporated herein by reference.

### BACKGROUND OF THE INVENTION

Night vision systems include image intensification, thermal imaging, and fusion monoculars, binoculars, and goggles, whether hand-held, weapon mounted, or helmet mounted. Image intensification night vision systems are typically equipped with one or more image intensifier tubes to allow an operator to see visible wavelengths of radiation (approximately 400 nm to approximately 900 nm). They work by collecting the tiny amounts of light, including the lower portion of the infrared light spectrum, that are present but may be imperceptible to our eyes, and amplifying it to the point that an operator can easily observe the image through an eyepiece. These systems have been used by soldier and law enforcement personnel to see in low light conditions, for example at night or in caves and darkened buildings. A drawback to image intensification night vision systems is that they may be attenuated by smoke and heavy sand storms and may not see a person hidden under camouflage.

Thermal imaging systems allow an operator to see people and objects because they emit thermal energy. These devices operate by capturing the upper portion of the infrared light spectrum, which is emitted as heat by objects instead of simply reflected as light. Hotter objects, such as warm bodies, emit more of this wavelength than cooler objects like trees or buildings. Since the primary source of infrared radiation is heat or thermal radiation, any object that has a temperature radiates in the infrared. One advantage of infrared sensors is that they are less attenuated by smoke and dust and a drawback is that they typically do not have sufficient resolution and sensitivity to provide acceptable imagery of a scene. In a thermal imager, light entering a thermal channel may be sensed by a two-dimensional array of infrared-sensor elements. The sensor elements create a very detailed temperature pattern, which is then translated into electric impulses that are communicated to a processor. The processor may then translate the information into data for a display. The display may be aligned for viewing through an ocular lens within an eyepiece.

Fusion systems have been developed that combine image intensification with thermal imaging. The image intensification information and the infrared information are fused together to provide a fused image that provides benefits over just image intensification or just thermal imaging. Whereas image intensification night vision system can only see visible wavelengths of radiation, a fusion system provides additional information by providing heat information to the operator.

FIG. 1A is a block diagram of an electronically fused vision system 100 and FIG. 1B is a block diagram of an optically fused vision system 100′. The components are housed in a housing 102, which can be mounted to a military helmet, and are powered by a battery (not shown). Information from an image intensification (I²) channel 106 and a thermal channel 108 are fused together in an image combiner 130 for viewing by an operator 128 through an eyepiece 110. The eyepiece 110 may have one or more ocular lenses for magnifying and/or focusing a fused image 140. The I² channel 106 is configured to process information in a first range of wavelengths (the visible portion of the electromagnetic spectrum from 400 nm to 900 nm) and the thermal channel 108 is configured to process information in a second range of wavelengths (the infrared portion of the electromagnetic spectrum from 7,000 nm-14,000 nm). The 12 channel 106 may have an objective focus 112 and an image intensifier 114 (e.g. for example an I² tube) and the thermal channel 108 may have an objective focus 116 and an infrared sensor 118 (e.g. for example a SWIR (shortwave infrared), MWIR (medium wave infrared), or LWIR (long wave infrared). Depending on the type of sensors in the I² channel 106 and the thermal channel 108, and the type of image combiner 130, 130′ utilized, the output of the I² channel 106 may or may not be processed in a processor 120B and the output of the thermal channel 108 may or not be processed in a processor 120A.

In the electronically fused vision system 100, the output from the I² channel 106 may be digitized with a CCD or CMOS and associated electronics and the output from the thermal channel 108 may already be in a digitized format. The image combiner 130 may take the two outputs and electronically combine them and direct the output to a display 132 aligned with the eyepiece 110.

In an optically fused vision system 100′, the image combiner 130′ may be a beam splitter. One input side of the beam splitter may be aligned with the output of the I² channel 106 and the other input side of the beam splitter may be aligned with a display 132 coupled to the thermal channel 108. The two inputs may be optically combined in the beam splitter with the output side of the beam splitter aligned with eyepiece 110. As noted above, the output of either or both of the channels may be digitized before entering the image combiner.

Due to manufacturing tolerances, non-precision optics, or by design, the fields of view of the I² channel 106 and the thermal channel 108 may be different causing the output 104″ from the I² channel 106 to appear larger (as shown) or smaller than the output 104′ from the thermal channel 108. This difference in size may decrease viewability of the fused image 140 viewable through the eyepiece 110.

### BRIEF DESCRIPTION OF THE DRAWINGS

For a better understanding of the invention, together with other objects, features and advantages, reference should be made to the following detailed description which should be read in conjunction with the following figures wherein like numerals represent like parts:

FIG. 1A is a block diagram of an electronically fused vision system.

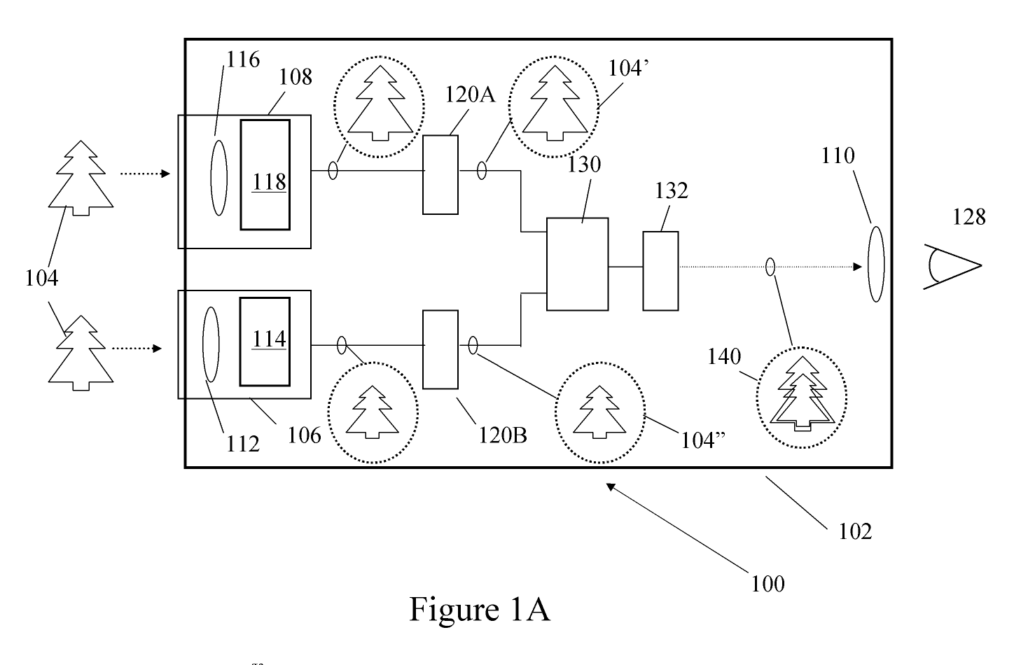

FIG. 1B is a block diagram of an optically fused vision system.

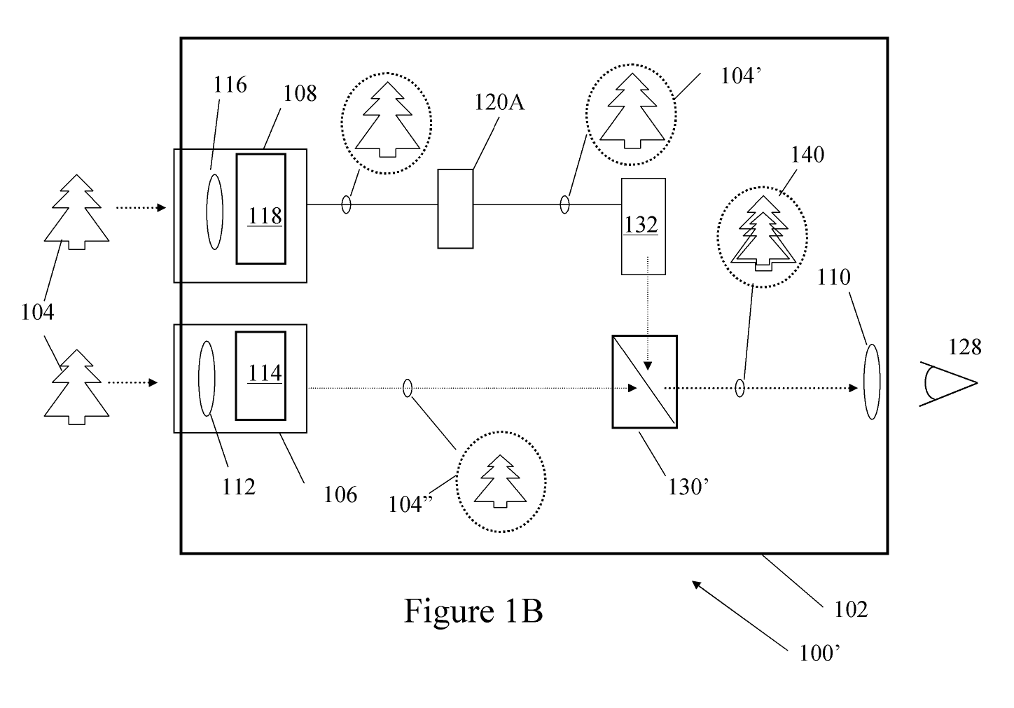

FIG. 2A is block diagram of a first fusion vision system consistent with the invention.

FIG. 2B is block diagram of a second fusion vision system consistent with the invention.

FIG. 3 illustrates resizing the output of an image intensification or thermal channel consistent with the invention.

FIG. 4 is a first calibration target useful in a method consistent with the invention.

FIG. 5 is a second calibration target useful in a method consistent with the invention.

### DETAILED DESCRIPTION

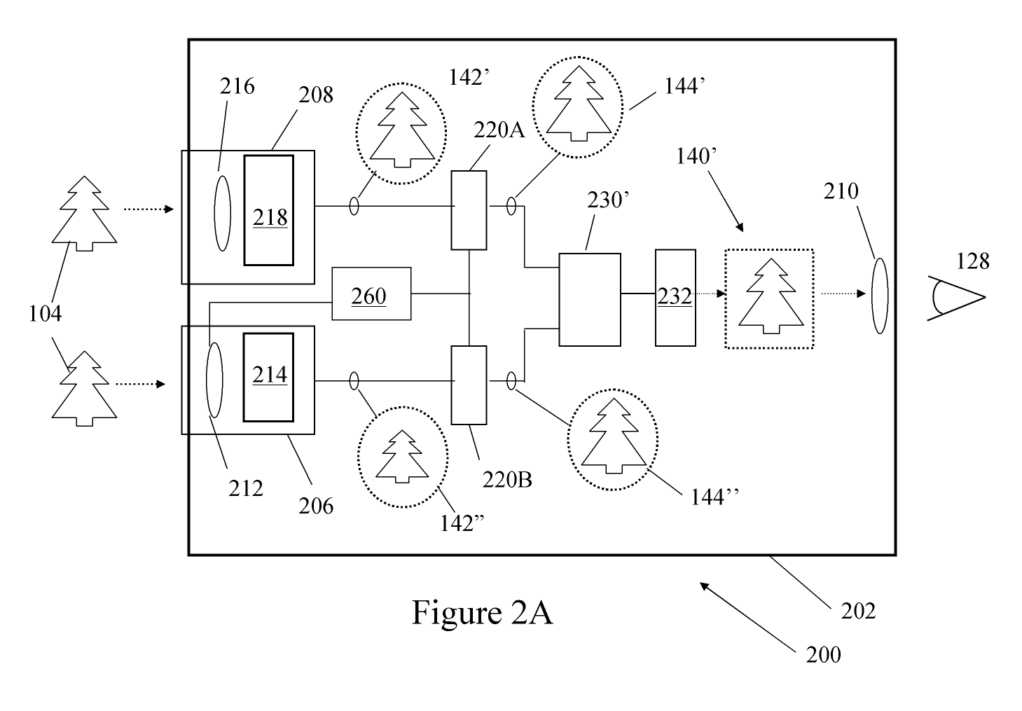

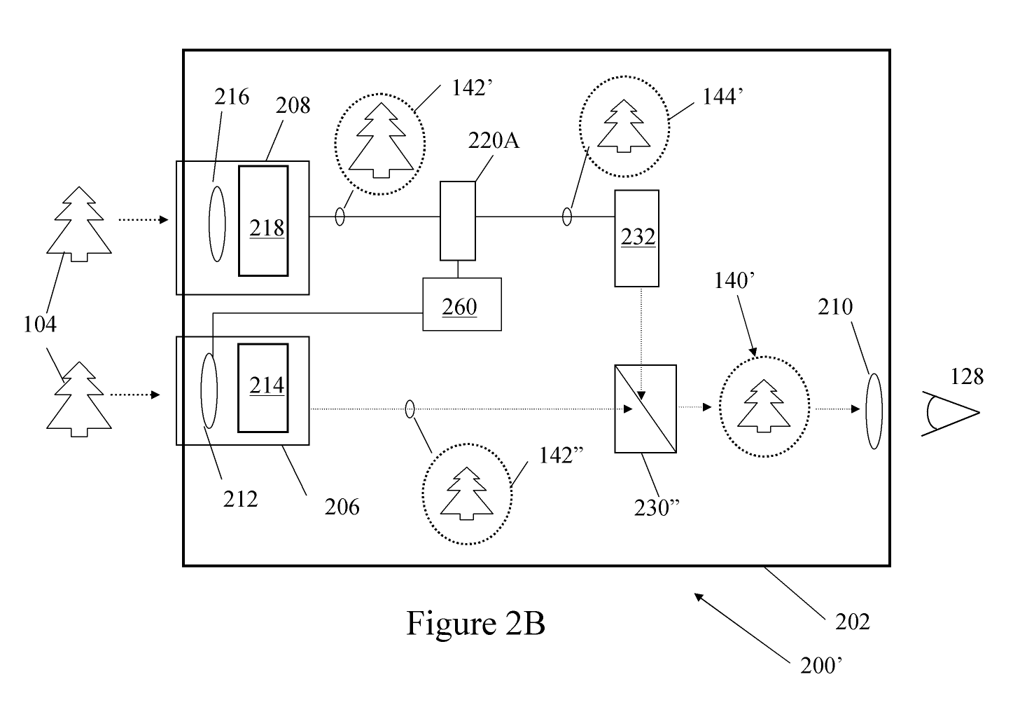

FIG. 2A is a block diagram of a first fusion vision system 200 and FIG. 2B is a block diagram of a second fusion vision system 200′, consistent with the present invention. The electronics and optics may be housed in a housing 202. Information from a first channel (I²) channel 206 and a second channel 208 may be fused together in an image combiner 230, 230′ for viewing by an operator 128. A channel may be an path through which scene information may travel. Depending on the type of sensors in the I² channel 206 and the thermal channel 208, and the type of image combiner 230, 230′ utilized, the output of the I² channel 206 may or may not be processed in a processor 220B and the output of the thermal channel 208 may or not be processed in a processor 220A. The first channel 206 may be configured to process information in a first range of wavelengths (the visible portion of the electromagnetic spectrum from approximately 400 nm to approximately 900 nm) and the second channel 208 may be configured to process information in a second range of wavelengths (from approximately 7,000 nm to approximately 14,000 nm). The low end and the high end of the range of wavelengths may vary without departing from the invention.

The first channel 206 may have an objective focus 212 and an image intensifier (I²) 214. Suitable I²s may be Generation III I² tubes. Alternatively, other sensor technologies including near infrared electron bombarded active pixel sensors or short wave InGaAs arrays may be used without departing from the invention. Although the fusion vision systems 200, 200′ are shown as monocular, it may be a binocular without departing from the invention.

The second channel 208 may be a thermal channel having an objective focus 216 and an infrared sensor 218. The infrared sensor 218 may be a SWIR (shortwave infrared), MWIR (medium wave infrared), or LWIR (long wave infrared) sensor, for example a focal plane array or microbolometer. The output from the infrared sensor 218 may be processed in processor 220A before being combined in a combiner 230′,230″ with information from the first channel 206. The combiner 230′, 230″ may be an electronic or optical combiner (e.g. a partially reflective beam splitter). The fusion night vision system 200, 200′ may utilize one or more displays 232 aligned with either the image combiner 230″ or an eyepiece 210. The displays may be monochrome or color organic light emitting diode (OLED) microdisplay. The eyepiece 210 may have one or more ocular lenses for magnifying and focusing the fused image.

Due to manufacturing tolerances, non-precision optics, or by design, the fields of view of the I² channel 206 and the thermal channel 208 may be different causing the output 142″ from the I² channel 206 to appear smaller, or larger, than the output 142′ from the thermal channel 208. The processors 220A, 220B may be configured to electronically resize one of a first and a second output from the first or second channels to improve viewability of the scene caused by the two channels having differing fields of view.

As shown in FIG. 2A, the processor 220B may resize its input 142″ such that its output 144″ is closer in size to the output 144″ of the processor 220A. After the outputs 144′ and 144″ are combined in combiner 230′ the output 140′ is a fused image aligned with eyepiece 210. As shown in FIG. 2B, the processor 220A may resize its input 142′ such that its output 144′ is closer in size to the output 142″ from the I² channel 206. After the outputs 144′ and 142″ are combined in combiner 230″ the output 140′ is a fused image aligned with eyepiece 210. Operator 128 looking through the eyepiece 210 may be able to see a fused image 140′ of a target or area of interest 104 made up of the first or second image fused with the resized second or first image.

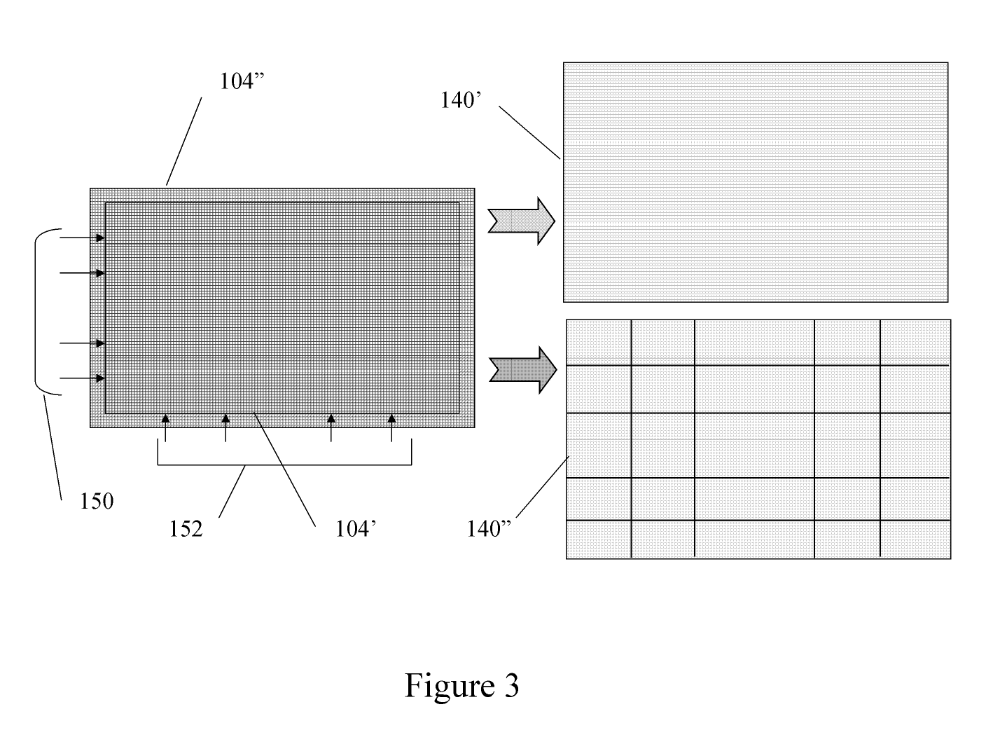

FIG. 3 illustrates resizing the output of an image intensification or thermal channel consistent with the invention. If the output 142″ of the first channel 206 is smaller than the output 142′ of the second channel 208, one of the processors 220A, 220B can resize the output such that the two images generally appear the same size when viewed through the eyepiece 210. The processor 220A, 220B may add one or more rows 150 and/or columns 152 in order for the two images to generally appear the same size when viewed through the eyepiece 210. The processor 220A, 220B may copy an adjacent pixel value and assign it to the added pixel or the processor may interpolate a pixel value from adjacent pixels. Alternatively, processor 220A, 220B may remove one or more rows 150 and/or columns 152.

The addition or subtraction of rows 150 and/or columns 152 may not be uniformly distributed in the display. As shown, the added rows 150 and columns 152 may be added away from the center of the field of view as the edges of a lens tend to have more imperfections than the central region.

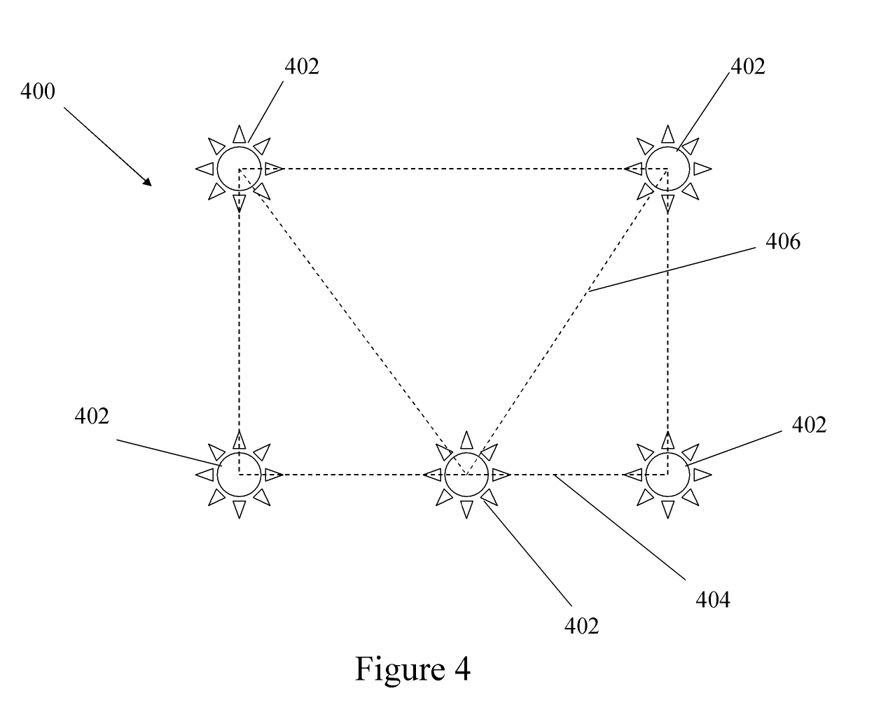

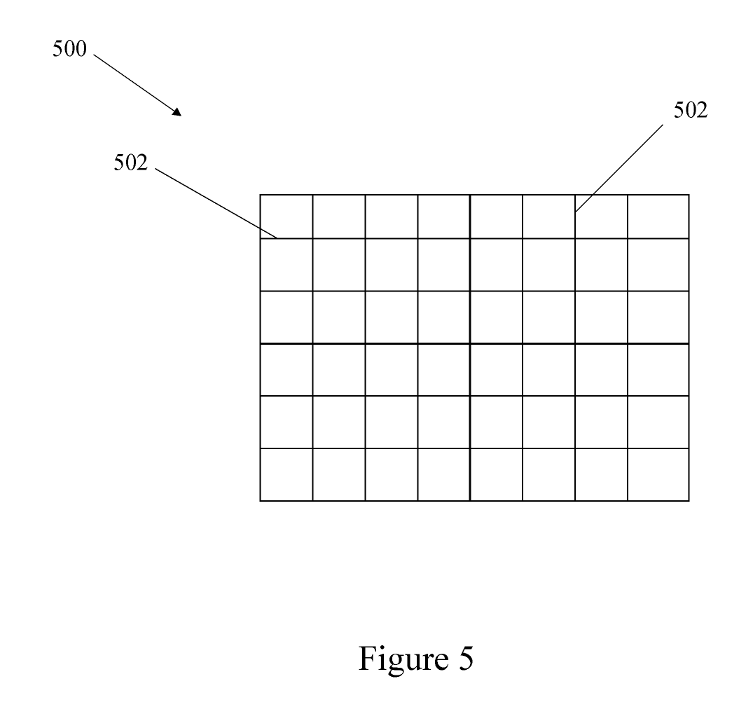

The processor may be manually or automatically resized during or after the manufacturing/assembly process. In a manual process, the processor 220A, 220B may be instructed to add/or subtract a predetermined number of rows 150 or columns 152. In an automated process, the fusion vision system 200, 200′ may be pointed at a calibration target 400, 500 (see FIGS. 4, 5) and it may internally determine how many rows and/or columns to be added or subtracted, and where. The target may have one or more elements that can be seen by the first and the second channels 206, 208. The elements may be a plurality of individual spaced elements, a continuous element, a grid or coil of heated wire, or other item that can be seen by the first and the second channels 206, 208, arranged in a pattern.

FIG. 4 is a first calibration target 400 useful in a method consistent with the invention. It may have two or more elements 402, for example a resistive or conductive element, for example an electrical filament or a copper conductor, arranged in a pattern 404, 406 to determine how much one of the outputs needs to be resized in order for the images to generally appear to be the same size when viewed through the eyepiece 210.

FIG. 5 is a second calibration target 500 useful in a method consistent with the invention. The pattern 500 may be more extensive and allow for better calibration of the outputs to correct for localized defects. The pattern 500 may be a plurality of individual elements 502 aligned in a grid or a continuous element arranged in a grid or other pattern.

An actuator disposed within or extending out of the housing 202 may be used to initiate the resizing.

The processors 220A, 220B may also receive distance to target information that a parallax compensation circuit 260 uses to shift an image in a display to compensate for errors caused by parallax.

According to an aspect, the present disclosure may provide a scene imager a fusion vision system including a housing, a first channel having a first sensor and a first objective lens at least partially disposed within the housing for processing scene information in a first range of wavelengths, a second channel having a second sensor and a second objective lens at least partially disposed within the housing for processing scene information in a second range of wavelengths, a processor configured to resize one of a first and a second output of one of the first and second channels to improve viewability, and an image combiner for combining the output of the first or second channels with the resized output of the second or first channels.

According to an aspect, the present disclosure may provide a scene imager a fusion vision system including a housing, a first sensor at least partially disposed within the housing for processing information in a first range of wavelengths, a second sensor at least partially disposed within the housing for processing information in a second range of wavelengths, a processor configured to resize one of a first and a second output of one of the first and second sensors, and an image combiner for combining the output of the first or second sensor with the resized output of the second or first sensor for viewing by an operator.

According to an aspect, the present disclosure may provide a method of displaying fused information representative of a scene, the method includes: acquiring information representative of a scene from a first channel configured to process information in a first range of wavelengths; acquiring information representative of the scene from a second channel configured to process information in a second range of wavelengths; resizing one of the first and the second acquired information to improve viewability of the scene.

Although several embodiments of the invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

What is claimed is:

1. A fusion vision system, comprising:
a housing;
a first channel having a first sensor and a first objective lens at least partially disposed within the housing for processing scene information in a first range of wavelengths;
a second channel having a second sensor and a second objective lens at least partially disposed within the housing for processing scene information in a second range of wavelengths;
a processor configured to resize one of a first and a second output of one of the first and second channels; and
an image combiner for combining the output of the first or second channel with the resized output of the second or first channel.

2. The fusion vision system of claim 1, wherein the first range of wavelengths is approximately 400 nm to approximately 900 nm and the second range of wavelengths is approximately 7,000 nm to approximately 14,000 nm.

3. The fusion vision system of claim 1, further comprising a display for projecting an image to an operator.

4. The fusion vision system of claim 3, wherein the display has a plurality of individual pixels arranged in rows and columns.

5. The fusion vision system of claim 1, wherein the processor adds or removes one or more row or columns of pixels before displaying in a display.

6. The fusion night vision system of claim 1, wherein the first channel has an objective focus and an image intensification tube and the second channel has an objective focus and an infrared sensor.

7. The fusion night vision system of claim 1, wherein the image combiner is a partial beam splitter.

8. The fusion night vision system of claim 1, wherein the image combiner is a selected one of a digital fusion mixer and an analog fusion mixer.

9. The fusion night vision system of claim 8, wherein the image combiner is an optical image combiner.

10. The fusion night vision system of claim 1, further comprising a display coupled to the image combiner, the display having a plurality of pixels arranged in rows and columns for projecting an image to an operator.

11. The fusion night vision system of claim 1, further comprising a parallax compensation circuit coupled to the display and configured to receive distance to target information.

12. The fusion night vision system of claim 1, wherein the processor resizes the first or second output to correct for the two channels having differing fields of view.

13. The fusion night vision system of claim 3, further comprising an eyepiece aligned with the display for viewing a fused image from the first and the second channels.

14. The fusion night vision system of claim 11, further comprising an objective lens aligned with the first channel for determining the distance to target information.

15. A method of displaying fused information representative of a scene, the method comprising the steps of:
acquiring first information representative of the scene from a first channel configured to process information in a first range of wavelengths;
acquiring second information representative of the scene from a second channel configured to process information in a second range of wavelengths; and
resizing one of the first and the second acquired information to improve viewability of the scene.

16. The method of claim 15, wherein a processor calculates a value for an added pixel based on a value of a surrounding pixel and the calculated value is displayed in a display for viewing by an operator.

17. The method of claim 15, wherein information from a selected one of the first and the second channels is shifted on a display by a parallax compensation circuit so as to align the first information and the second information when viewed through an eyepiece.

18. The method of claim 15, wherein the first channel has an objective focus and an image intensification tube and the second channel has an infrared sensor and an objective focus.

19. The method of claim 15, wherein movement of the objective lens communicates a signal to a parallax compensation circuit indicative of the distance to target.

20. A fusion vision system, comprising:
a housing;
a first sensor at least partially disposed within the housing for processing information in a first range of wavelengths;
a second sensor at least partially disposed within the housing for processing information in a second range of wavelengths;
a processor configured to resize one of a first and a second output of one of the first and second sensors; and
an image combiner for combining the output of the first or second sensor with the resized output of the second or first sensor for viewing by an operator.

21. The fusion vision system of claim 20, further comprising a display having a plurality of individual pixels arranged in rows and columns for projecting an image to an operator.

22. The fusion vision system of claim 21, wherein the processor adds or removes one or more row or columns of pixels before displaying in the display.

23. The fusion vision system of claim 20, wherein the image combiner is a partial beam splitter.

24. The fusion vision system of claim 20, wherein the image combiner is a selected one of a digital fusion mixer and an analog fusion mixer.

25. The fusion vision system of claim 24, wherein the image combiner is an optical image combiner.

26. The fusion vision system of claim 20, further comprising a parallax compensation circuit coupled to the display and configured to receive distance to target information.

27. The fusion vision system of claim 20, further comprising an eyepiece aligned with the display for viewing a fused image from the first and the second sensors.

28. The fusion vision system of claim 26, further comprising an objective lens aligned with the first sensor for determining the distance to target information.
